(19) United States
(12) Patent Application Publication
(10) Pub. No.: US 2026/0054378 A1
(43) Pub. Date: Feb. 26, 2026

(54) CONTROLLER AND CONTROL METHOD BASED ON VARIABLE STRUCTURE, AND RECORDING MEDIUM FOR PERFORMING SAME CONTROL METHOD

(71) Applicants: SEOUL NATIONAL UNIVERSITY R&DB FOUNDATION, Seoul (KR); RS AUTOMATION CO., LTD., Pyeongtaek-si (KR)

(72) Inventors: Dong Il Cho, Seoul (KR); Dae Young Yang, Seoul (KR); Tae-Ho Oh, Busan (KR); Sang-Hoon Lee, Seongnam-si (KR)

(21) Appl. No.: 19/106,977

(22) PCT Filed: Sep. 1, 2022
(86) PCT No.: PCT/KR2022/013140

§ 371 Date: Apr. 4, 2025

(30) Foreign Application Priority Data
Aug. 31, 2022 (KR) 10-2022-0110336

(51) Int. Cl. B25J 9/12

(52) U.S. Cl. CPC B25J 9/12

(57) ABSTRACT

A controller based on a variable structure comprises: a switching function calculation unit for receiving a position reference received from the outside of a motor and a plant to be controlled and a position feedback from the motor and plant, so as to calculate a switching function used for variable structure control; a variable structure high-order external disturbance estimation unit for estimating external disturbance applied to the motor and plant on the basis of the switching function, and outputting an estimated external disturbance signal; and a variable structure current command generation unit for generating a current command applied to the motor and plant, on the basis of the position reference, the position feedback from the motor and plant, the switching function, and the estimated external disturbance signal. Accordingly, the influence on a difference between a system model and an actual load model of an external disturbance compensator can be reduced.

### TECHNICAL FIELD

The present invention relates to a controller based on a variable structure and a control method, as well as a recording medium for performing the control method, more specifically, relates to a control technology that uses a variable structure-based higher-order external disturbance compensator for external disturbances applied to a motor and plant or a plant.

### DESCRIPTION OF NATIONAL SUPPORT RESEARCH AND DEVELOPMENT

This application has been made with the support of the Ministry of Small and Medium Enterprises and Startups World Class 300 (WC300) project (Development of Robot Motion Control Solution for Flexible Response of Smart Machines/Collaborative Robots, Project Unique No.: 9991008048, Detailed Project No.: S2563339).

### BACKGROUND ART

An industrial servo control system is a feedback control system that generates current using a position command and a position feedback from the motor and plant passed through the plant, ensuring that the position feedback follows the position command. Generally, servo systems are subject to various external disturbances such as gravity and friction, and when these are not compensated for, there is a problem where the position reaching performance deteriorates.

To solve this, a control method using variable structure control, a type of nonlinear control, and a variable structure-based external disturbance compensator has been proposed (Patent Document 1 of the Documents of Related Art). The method receives the reference input and position feedback to generate a switching function. Then, using the generated switching function, the external disturbance is estimated, and using the external disturbance estimation value and the system model, a control input is generated to make the switching function converge to zero. The corresponding method has the advantage of ensuring the performance and stability of the system.

However, the structure including a belt drive, which is commonly used in industrial servo systems, has a complex plant model. Therefore, when the difference between the system model and the actual system is large, the conventional variable structure-based external disturbance compensator, due to its structural characteristic of using the switching function and external disturbance estimation value prior to one sample to estimate the external disturbance of the current sample, may not sufficiently reduce the impact of model errors in the high-frequency band, leading to a decrease in the stability of the system.

Reducing the external disturbance estimation gain of the external disturbance compensator may solve the problem of reduced stability. However, in this case, the external disturbance compensation performance deteriorates, making it difficult to expect high performance from the system. To solve this problem, a robust control method is required that maintains the compensation effect for external disturbances of the external disturbance compensator while reducing the impact of the difference between the applied model and the actual model on the system, thereby ensuring the stability of the system and achieving higher control performance.

### DOCUMENTS OF RELATED ART

(Patent Document 1) KR 10-0172181 B1
(Patent Document 2) KR 10-2240722 B1
(Non-patent Document 1) Y. Eun, et al., “Discrete-time Variable Structure Controller with a Decoupled Disturbance Compensator and Its Application to a CNC Servomechanism,” IEEE Transactions on Control Systems Technology, vol. 7, no. 4, pp. 414-423, 1999.
(Non-patent Document 2) Han, J. S., Kim, T. I., Oh, T. H., Kim, Y. S., Lee, J. H., Kim, S. O., Lee, S. S., Lee, S. H., and Cho, D. I., “Frequency-Domain Design Method of Discrete-time Sliding Mode Control with Generalized Decoupled Disturbance Compensator for Industrial Servo Systems,” 12th IFAC Symposium on Robot Control (SYROCO 2018), Budapest, Hungary, Aug. 27-30, 2018.

### DISCLOSURE

### Technical Problem

Accordingly, the present invention is directed to solving the technical problem in this regard. An object of the present invention is to provide a controller that is capable of reducing the impact of the difference between the system model of the external disturbance compensator and the actual load model by applying a control method that uses a variable structure-based external disturbance compensator as a higher-order external disturbance compensator.

Another object of the present invention is to provide a control method using the controller.

Yet another object of the present invention is to provide a computer program stored on a medium to execute the control method.

### Technical Solution

To achieve an object of the present invention described above, there is provided a controller based on a variable structure, according to an embodiment. The controller includes: a switching function calculation unit configured to receive a position reference of a motor and plant to be controlled, and a position feedback from the motor and plant, and calculate a switching function used for a variable structure control; a variable structure high-order external disturbance estimation unit configured to estimate external disturbance applied to the motor and plant based on the switching function and output an estimated external disturbance signal; and a variable structure current command generation unit configured to generate a current command applied to the motor and plant, based on the position reference, the position feedback from the motor and plant, the switching function, and the estimated external disturbance signal.

In the embodiment of the present invention, the variable structure high-order external disturbance estimation unit may include: a time delay external disturbance storage unit configured to store the calculated estimated external disturbance signal up to estimated external disturbance values prior to at least two control cycles; and an estimated external disturbance calculation unit configured to calculate an estimated external disturbance signal of a current state by using the switching function, the position feedback acquired from the motor and plant, and an estimated external disturbance signal of previous control cycles stored in the time delay external disturbance storage unit.

In the embodiment of the present invention, the variable structure high-order external disturbance estimation unit may use a second-order or higher external disturbance estimator structure.

In the embodiment of the present invention, the controller based on a variable structure may receive the position feedback from the motor and plant, which is output from an encoder connected to the motor and plant, according to the current command input from the variable structure current command generation unit.

To achieve another object of the present invention described above, there is provided a control method based on a variable structure, according to an embodiment. The control method includes: calculating a switching function used for a variable structure control by receiving a position reference of a motor and plant to be controlled, and a position feedback from the motor and plant; outputting an estimated external disturbance signal by estimating external disturbance applied to the motor and plant based on the switching function; and generating a current command applied to the motor and plant, based on the position reference, the position feedback from the motor and plant, the switching function, and the estimated external disturbance signal.

In the embodiment of the present invention, the outputting of the estimated external disturbance signal may include: storing the calculated estimated external disturbance signal up to estimated external disturbance values prior to at least two control cycles; and calculating an estimated external disturbance signal of a current state by using the switching function, the position feedback acquired from the motor and plant, and the stored estimated external disturbance signal of previous control cycles.

In the embodiment of the present invention, the outputting of the estimated external disturbance signal may use a second-order or higher external disturbance estimator structure.

In the embodiment of the present invention, the control method based on a variable structure may further include: receiving the position feedback from the motor and plant from an encoder connected to the motor and plant, according to the current command.

To achieve yet another object of the present invention described above, there is provided a computer-readable recording medium, according to an embodiment. A computer program for performing the control method based on a variable structure is recorded on the computer-readable recording medium.

### Advantageous Effects

According to the controller based on a variable structure as described above, the impact of the difference between the system model of the external disturbance compensator and the actual load model can be reduced. Accordingly, the impact after the control bandwidth frequency of the external disturbance compensator can be reduced, thereby further ensuring the stability of the system.

### DESCRIPTION OF DRAWINGS

FIG. 1 is a block diagram of a controller based on a variable structure according to an embodiment of the present invention.

FIG. 2 is a block diagram of a variable structure high-order external disturbance estimator in FIG. 1.

FIG. 3 is a graph illustrating a current command applied to a motor and plant, as well as the estimated external disturbance values, according to the present invention.

FIG. 4 is a graph illustrating the position command applied to the motor and plant, as well as the position feedback acquired through an encoder, according to the present invention.

FIG. 5 is a flowchart of a control method based on a variable structure according to an embodiment of the present invention.

### MODE FOR DISCLOSURE

The following detailed description of the present invention will be made with reference to the accompanying drawings illustrating specific exemplary embodiments for carrying out the present invention. These embodiments will be described in detail enough to carry out the present invention by those skilled in the art. It should be understood that various embodiments of the present invention are different from one another but need not be mutually exclusive. For example, particular shapes, structures, and characteristics described herein in respect to an embodiment can be implemented in other embodiments without departing from the spirit and scope of the present invention. In addition, it should be understood that the position or arrangement of each constituent element in the respective disclosed embodiments may be changed without departing from the spirit and scope of the present invention. Therefore, the following detailed description is not intended to limit the present invention, and the scope of the present disclosure, if adequately explained, is limited only by the appended claims as well as all the scopes equivalent to the appended claims. Like reference numerals in the drawings refer to the same or similar functions throughout several aspects.

Hereinafter, exemplary embodiments of the present invention will be described in detail with reference to the drawings.

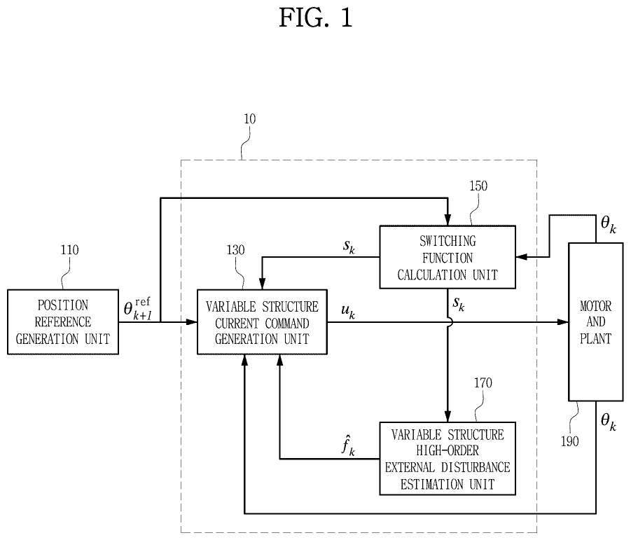

FIG. 1 is a block diagram of a controller based on a variable structure according to an embodiment of the present invention.

With reference to FIG. 1, a controller based on a variable structure (10, hereinafter referred to as a controller) according to the present invention includes a variable structure current command generation unit 130, a switching function calculation unit 150, and a variable structure high-order external disturbance estimation unit 170.

FIG. 1 additionally illustrates a position reference generation unit 110 and a motor and plant 190. However, these are shown for convenience of description, and the motor and plant may include any device capable of driving a load.

The controller 10 of the present invention may have software (application) installed and executed to perform control, and the configurations of the variable structure current command generation unit 130, the switching function calculation unit 150, and the variable structure high-order external disturbance estimation unit 170 may be controlled by the software executing on the controller 10 to perform the control.

The controller 10 may be a separate terminal or a module of a terminal. Additionally, the configurations of the variable structure current command generation unit 130, the switching function calculation unit 150, and the variable structure high-order external disturbance estimation unit 170 may be formed as an integrated module or composed of one or more modules. However, on the contrary, each configuration may also be composed of separate modules.

The controller 10 may have mobility or be fixed. The device 10 may be in the form of a server or engine and may also be referred to by other terms such as device, apparatus, terminal, user equipment (UE), mobile station (MS), wireless device, handheld device, etc.

The controller 10 may execute or create various software based on an operating system (OS), i.e., the system. The operating system is a system program that allows software to use the hardware of the device, and may include mobile computer operating systems such as Android OS, iOS, Windows Mobile OS, Bada OS, Symbian OS, Blackberry OS, as well as computer operating systems such as Windows family, Linux family, Unix family, MAC, AIX, HP-UX, and others.

The variable structure current command generation unit 130 receives as input the position reference of the motor and plant 190, which is received from the outside, and the position feedback obtained by measuring the state of the motor and plant 190 and the load driven by the encoder connected to the motor and plant 190.

The position reference and position feedback may be generated based on angular displacement (angular position), but this is not limited thereto, and may be information generated based on the angular displacement or angular velocity of the control target.

The specific configuration and operation method of the motor, plant, and encoder are well known in the art, and thus a detailed description thereof is omitted here.

The controller 10 may generate a control input to follow the position reference

$$( θ {}_{k}^{ref} )$$

received from the outside, in the environment of a discrete-time state-space equation as shown in Equation 1 below, using the input information.

$${x}_{k + 1} = {Ax}_{k} + B ( {u}_{k} + {f}_{k} ) \qquad [ Equation 1 ]$$

Here, xₖ=[θₖ ωₖ]^{T} is the state vector, θₖ is the position feedback, ωₖ is the velocity feedback, uₖ is the current command received from the variable structure current command generation unit 130, and fₖ is the external disturbance input from the outside.

$$A = [ \begin{matrix}1 & T \\ 0 & 1\end{matrix} ]$$

is the system matrix,

$$B = {[ \begin{matrix}\frac{{k}_{t} {T}^{2}}{2 J} & \frac{{k}_{t} T}{J}\end{matrix} ]}^{T}$$

is the input matrix, J is the inertia of the system, kₜ is the motor and plant torque constant, and T is the control cycle of the variable structure controller.

The received position reference may generate a reference state vector as shown in Equation 2 below and provide the position reference (or command) to the variable structure current command generation unit 130 and the switching function calculation unit 150.

$${x}_{k}^{r e f} = [ \begin{matrix}{θ}_{k}^{r e f} & {ω}_{k}^{r e f}\end{matrix} ] \qquad [ Equation 2 ]$$

Here,

$${θ}_{k}^{ref}$$

is the position reference.

The reference state vector

$$( {x}_{k}^{ref} )$$

includes the position reference

$$( θ {}_{k}^{ref} )$$

and the velocity reference

$$( ω {}_{k}^{ref} ) ,$$

and the position reference

$$( θ {}_{k}^{ref} )$$

is provided to the variable structure current command generation unit 130 and the switching function calculation unit 150 to perform control that follows the position reference

$$( θ {}_{k}^{ref} ) .$$

The switching function calculation unit 150 receives the position reference and the position feedback from the motor and plant 190 to calculate the switching function used in the variable structure control.

The switching function output from the switching function calculation unit 150 is defined as shown in Equation 3 below.

$${s}_{k} = G {e}_{k} \qquad [ Equation 3 ]$$

Here, eₖ is the error function, defined as

$${e}_{k} = {x}_{k} - {x}_{k}^{ref} ,$$

and xₖ is the state variable, defined as

$${x}_{k} = {[ {θ}_{k} \frac{{θ}_{k} - {θ}_{k - 1}}{T} ]}^{T} .$$

G is the switching function gain vector.

The variable structure high-order external disturbance estimation unit 170 estimates the external disturbance applied to the motor and plant 190 based on the switching function and outputs the estimated external disturbance signal. The external disturbance estimation value generated in the variable structure high-order external disturbance estimation unit 170 is defined as shown in Equation 4 below.

$${\hat{f}}_{k + 1} = {\hat{f}}_{k} + {g}_{1} {( GB )}^{- 1} ( {s}_{k} - q {s}_{k - 1} + η sat ( \frac{{s}_{k - 1}}{ϕ} ) ) + {\sum }_{i = 1}^{n} {g}_{i + 1} \cdot {h}_{i} ( {\hat{f}}_{k} , {\hat{f}}_{k - 1} , … , {\hat{f}}_{k - n - 1} ) \qquad [ Equation 4 ]$$

In case of an external disturbance estimator of a higher order than a first order, it has the advantage of quickly responding to external disturbances occurring at the control bandwidth frequency of the external disturbance compensator, while reducing the impact of model errors appearing in other frequency bands.

Accordingly, a second, third or higher-order external disturbance estimator structure may be applied to the variable structure high-order external disturbance estimation unit 170 of the present invention. As an example, the application of the variable structure high-order external disturbance estimation unit 170 is explained by applying a second-order external disturbance estimator structure. The second-order external disturbance estimator based on a variable structure is defined as shown in Equation 5 below.

$${\hat{f}}_{k + 1} = {\hat{f}}_{k} + {g}_{1} {( GB )}^{1} ( {s}_{κ} - q {s}_{k - 1} + η sat ( \frac{{s}_{k - 1}}{ϕ} ) ) + {g}_{2} \cdot ( {\hat{f}}_{k} - {\hat{f}}_{k - 1} ) \qquad [ Equation 5 ]$$

Here, g₁, g₂ is the external disturbance estimation gain, and satisfies g₁+g₂≤1, 0<g₁<1, 0<g₂<1. q is the velocity parameter at which the error function reaches the sliding surface, η is the gain of the saturation function, and ϕ is the parameter that determines the boundary of the saturation function. sat(t) is a saturation function, where it takes a value of −1 when t is less than −1, takes the same value as t when t is equal to or greater than −1 and equal to or less than 1, and takes a value of 1 when t is greater than 1.

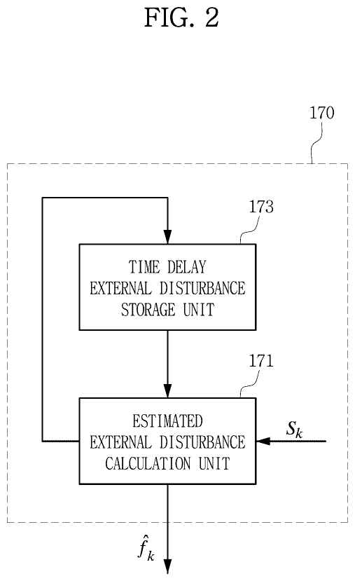

With reference to FIG. 2, the variable structure high-order external disturbance estimation unit 170 may include a time delay external disturbance storage unit 173 and an estimated external disturbance calculation unit 171.

The time delay external disturbance storage unit 173 may store the estimated external disturbance signal calculated by the estimated external disturbance calculation unit 171 up to the estimated external disturbance values prior to at least two control cycles.

The estimated external disturbance calculation unit 171 may calculate the estimated external disturbance signal of the current state by using the switching function, the position feedback acquired from the motor and plant 190, and the estimated external disturbance signal from the previous control cycles stored in the time delay external disturbance storage unit 173.

The variable structure current command generation unit 130 calculates the current command applied to the motor and plant 190 based on the position reference, the switching function, and the external disturbance estimation value, and the current command is defined as shown in Equation 6 below.

$${u}_{k} = - {\hat{f}}_{k} + {( G B )}^{- 1} ( {Gx}_{k + 1}^{r e f} - G A {x}_{k} + q {s}_{k} - η sat ( \frac{{s}_{k}}{ϕ} ) ) \qquad [ Equation 6 ]$$

The current command generated by the variable structure current command generation unit 130 generates a current command so that the switching function becomes zero, causing the state variable to follow the reference state vector.

The controller based on a variable structure according to embodiments of the present invention may reduce the impact of the difference between the system model used in the external disturbance estimator and the actual load model.

Accordingly, compensation for external disturbances within the control bandwidth frequency of the external disturbance compensator is possible, and the impact of model errors after the control bandwidth frequency may be sufficiently reduced, thereby further ensuring the stability of the system.

Hereinafter, the technical features of the controller based on a variable structure according to embodiments of the present invention will be explained in more detail through experimental examples of the present invention.

The control target was a belt drive, and the experiment was conducted using a 400 W servo driver. The control cycle of the variable structure controller is 0.125 ms, and the inertia ratio (J) between the control target and the motor and plant is 11.2 times. The experiment was conducted under the driving conditions where the target position was 100,000 counts, the maximum velocity was 500 rpm, and the acceleration/deceleration time was 20 ms. The parameters of the controller were set as shown in Table 1 below.

TABLE 1

| Parameter | Value |
|---|---|
| G | [242 1] |
| q | 0.98 |
| φ | 10 |
| η | 0.15 |
| g₁ | 0.0039 |
| g₂ | 0.9111 |
| kₜ | 0.3298 |

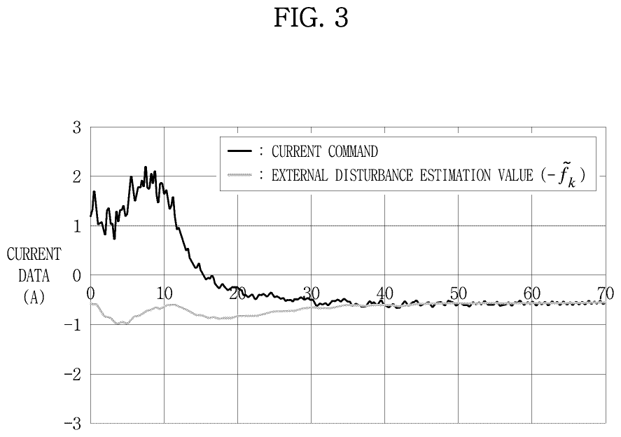

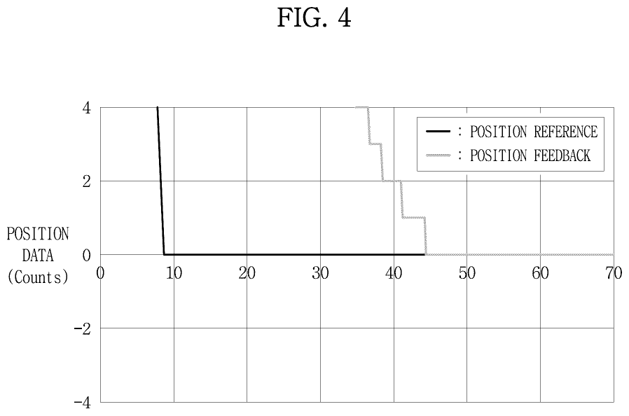

FIG. 3 is a graph illustrating the current command and the estimated external disturbance values used in the controller based on a variable structure of the present invention, and FIG. 4 is a graph illustrating the position command and position feedback when the target position is reached, with the application of the controller based on a variable structure of the present invention.

With reference to FIG. 3 and FIG. 4, it can be confirmed that no vibrations or overshoot occur in the structure with the application of the controller based on a variable structure of the present invention, and the system operates stably.

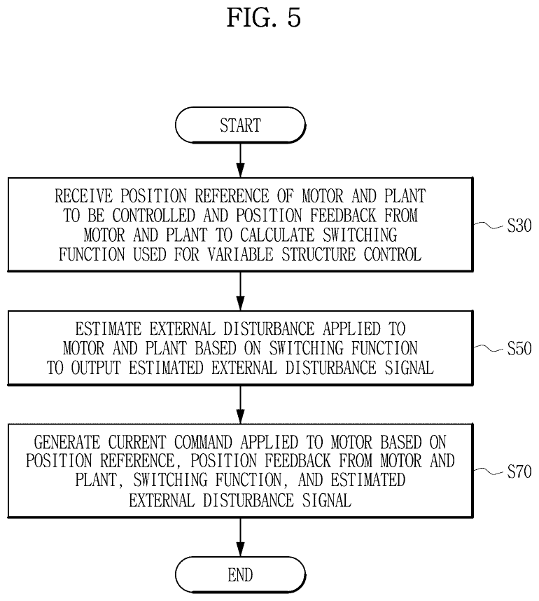

FIG. 5 is a flowchart of a control method based on a variable structure according to an embodiment of the present invention.

The control method based on a variable structure according to this embodiment may be carried out in a configuration that is substantially the same as the controller 10 in FIG. 1. Therefore, the constituent elements that are the same as those in the controller 10 in FIG. 1 are assigned the same reference numerals, and repeated descriptions are omitted.

Additionally, the control method based on a variable structure according to this embodiment may be executed by software (application) for performing the control.

In an embodiment, an additional step of receiving the position feedback from the motor and plant from the encoder connected to the motor and plant according to the current command may be included.

The position reference of a motor and plant to be controlled, received from the outside, and the position feedback from the motor and plant are received to calculate a switching function used in the variable structure control (step S30).

Based on the switching function, the external disturbance applied to the motor and plant is estimated, and the estimated external disturbance signal is output (step S50). Here, the step of outputting the estimated external disturbance signal (step S50) may use a second-order or higher external disturbance estimator structure. In case of an external disturbance estimator of a higher order than a first order, it has the advantage of quickly responding to external disturbances occurring at the control bandwidth frequency of the external disturbance compensator, while reducing the impact of model errors appearing in other frequency bands.

The step of outputting the estimated external disturbance signal (step S50) may include the steps of storing the calculated estimated external disturbance signal up to the estimated external disturbance values prior to at least two control cycles, and calculating the estimated external disturbance signal of the current state by using the switching function, the position feedback acquired from the motor and plant, and the stored estimated external disturbance signal of the previous control cycles.

Based on the position reference, the position feedback from the motor and plant, the switching function, and the estimated external disturbance signal, the current command applied to the motor and plant is generated (step S70).

The current command generated in step S70 generates a current command so that the switching function becomes zero, causing the state variable to follow the reference state vector.

The control method based on a variable structure, as described, may be implemented as an application or in the form of program instructions that may be performed through various computer constituent elements, and these instructions may be recorded on a computer-readable recording medium. The computer-readable recording medium may include program instructions, data files, data structures, or the like, in a stand-alone form or in a combination thereof.

The program instructions recorded in the computer-readable recording medium may be designed and configured specifically for the present invention or may be publicly known and available to those skilled in the field of computer software.

Examples of the computer-readable recording medium may include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions.

Examples of the program instructions include machine codes made by a compiler, as well as high-language codes that may be executed by a computer, using an interpreter. The above hardware devices may be configured to operate as one or more software modules in order to perform the operation according to the present invention, and vice versa.

While the present invention has been described above with reference to the embodiments, it may be understood by those skilled in the art that the present invention may be variously modified and changed without departing from the spirit and scope of the present invention disclosed in the claims.

### DESCRIPTION OF REFERENCE NUMERALS

10: Controller
110: Position reference generation unit
130: Variable structure current command generation unit
150: Switching function calculation unit
170: Variable structure high-order external disturbance estimation unit
190: Motor and plant
171: Estimated external disturbance calculation unit
173: Time delay external disturbance storage unit

1. A controller based on a variable structure, comprising:
a switching function calculation unit configured to receive a position reference of a motor and plant to be controlled, and a position feedback from the motor and plant, and calculate a switching function used for a variable structure control;
a variable structure high-order external disturbance estimation unit configured to estimate external disturbance applied to the motor and plant based on the switching function and output an estimated external disturbance signal; and
a variable structure current command generation unit configured to generate a current command applied to the motor and plant, based on the position reference, the position feedback from the motor and plant, the switching function, and the estimated external disturbance signal.

2. The controller of claim 1, wherein the variable structure high-order external disturbance estimation unit comprises:
a time delay external disturbance storage unit configured to store the calculated estimated external disturbance signal up to estimated external disturbance values prior to at least two control cycles; and
an estimated external disturbance calculation unit configured to calculate an estimated external disturbance signal of a current state by using the switching function, the position feedback acquired from the motor and plant, and an estimated external disturbance signal of previous control cycles stored in the time delay external disturbance storage unit.

3. The controller of claim 2, wherein the variable structure high-order external disturbance estimation unit uses a second-order or higher external disturbance estimator structure.

4. The controller of claim 1, wherein the controller receives the position feedback from the motor and plant, which is output from an encoder connected to the motor and plant, according to a current command input from the variable structure current command generation unit.

5. A control method based on a variable structure, comprising:
calculating a switching function used for a variable structure control by receiving a position reference of a motor and plant to be controlled, and a position feedback from the motor and plant;
outputting an estimated external disturbance signal by estimating external disturbance applied to the motor and plant based on the switching function; and
generating a current command applied to the motor and plant, based on the position reference, the position feedback from the motor and plant, the switching function, and the estimated external disturbance signal.

6. The control method of claim 5, wherein the outputting of the estimated external disturbance signal comprises:
storing the calculated estimated external disturbance signal up to estimated external disturbance values prior to at least two control cycles; and
calculating an estimated external disturbance signal of a current state by using the switching function, the position feedback acquired from the motor and plant, and the stored estimated external disturbance signal of previous control cycles.

7. The control method of claim 6, wherein the outputting of the estimated external disturbance signal uses a second-order or higher external disturbance estimator structure.

8. The control method of claim 5, further comprising:
receiving the position feedback from the motor and plant from an encoder connected to the motor and plant, according to the current command.

9. A non-transitory computer-readable storage medium on which a computer program for performing the control method based on the variable structure according to claim 5 is recorded.
